(19) United States
(12) Patent Application Publication
(10) Pub. No.: US 2008/0311548 A1
(43) Pub. Date: Dec. 18, 2008

(54) Math educational apparatus

(76) Inventor: Peigen Jiang, Sammamish, WA (US)

Correspondence Address: PEIGEN JIANG, 19480 SE 28TH PLACE, SAMMAMISH, WA, 98075, US

(21) Appl. No.: 11/761,910

(22) Filed: Jun. 12, 2007

(51) Int. Cl. G09B 5/00

(52) U.S. Cl. 434/201

(57) ABSTRACT

A math educational apparatus is disclosed, which comprises a first and second storage unit coupled to at least one number generator, a third storage unit coupled to an arithmetic operation selection device, an arithmetic unit for performing a correct arithmetic operation on contents of the first and second storage unit, the arithmetic operation being determined by a content of the third storage unit, a fourth storage unit coupled to a number input device, a comparator for comparing an output of the arithmetic unit and a content of the fourth storage unit, and a display device coupled to outputs of the first, second, third and fourth storage unit for displaying contents thereof, wherein displayed contents of the first, second and third storage unit represents a math question and a displayed content of the fourth storage unit represents an answer to the math question.

### BACKGROUND

The present invention relates generally to learning devices for young student, and, more particularly, to a math educational apparatus.

Teaching young student arithmetic, i.e., addition, subtraction, multiplication, and division, requires many repeated exercises. One of the conventional math learning aids is a flash card system. In the flash card system, each math question is printed on a flash card. Then the flash cards are presented to a student as quizzes. However, since there are large number of math questions, an exhaustive flash card system would require large number of flash cards, therefore is not very convenient. More importantly, such flash card system lacks interactive or multimedia capability, and young students hardly view it as a toy. Then practicing math with such flash card system is not very enticing for young students.

As such, what is desired is math educational apparatus that is easy to use, and can provide multimedia interactions with its users.

### SUMMARY

The present invention discloses a hand-held math educational apparatus for young students. In one embodiment of the present invention, the math educational apparatus comprises a first and second storage unit coupled to at least one number generator, a third storage unit coupled to an arithmetic operation selection device, an arithmetic unit for performing a correct arithmetic operation on contents of the first and second storage unit, the arithmetic operation being determined by a content of the third storage unit, a fourth storage unit coupled to a number input device, a comparator for comparing an output of the arithmetic unit and a content of the fourth storage unit, and a display device coupled to outputs of the first, second, third and fourth storage unit for displaying contents thereof, wherein displayed contents of the first, second and third storage unit represents a math question and a displayed content of the fourth storage unit represents an answer to the math question.

In another embodiment of the present invention, the math educational apparatus further comprises a logic unit configured to control data receiving of the first, second and fourth storage unit, and the fourth storage unit stores a number from the number input device for a first predetermined period of time and then stores a number from the arithmetic unit for a second predetermined period of time, and the data receiving changed from the number input device to the arithmetic unit is controlled by the logic unit.

In yet another embodiment of the present invention, the math educational apparatus further comprises a solar panel for supplying power to the math educational apparatus.

The construction and method of operation of the invention, however, together with additional objects and advantages thereof, will be best understood from the following description of specific embodiments when read in connection with the accompanying drawings.

### BRIEF DESCRIPTION OF THE DRAWING

FIG. 1 is a perspective view of a math education apparatus 100 according to one embodiment of the present invention.

FIG. 2 is a block diagram illustrating a circuit implementation of the math educational apparatus of FIG. 1.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein. It should be noted that the features illustrated in the drawings are not necessarily drawn to scale.

### DESCRIPTION

The following will provide a detailed description of a math educational apparatus that can generate random math questions and response to users' answers. The math educational apparatus can be made very inexpensively and operate on battery or solar power. Therefore, the math education apparatus can be used by young student as a hand-held device.

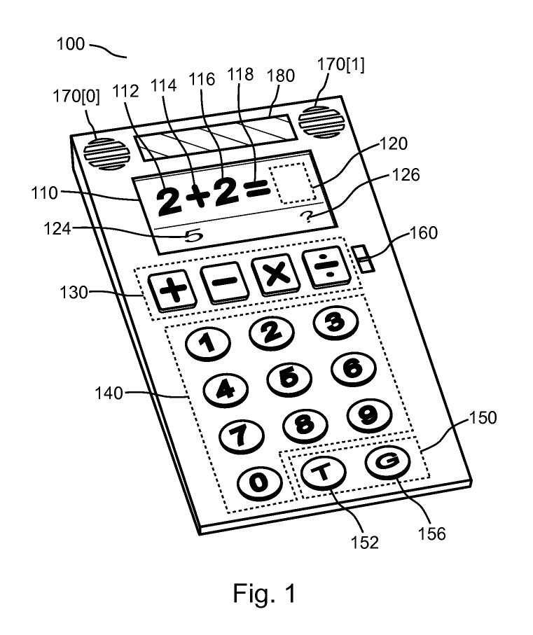

FIG. 1 is a perspective view of a math educational apparatus 100 according to one embodiment of the present invention. The math educational apparatus 100 comprises a display screen 110, a plurality of math operation selection buttons 130, a set of number input buttons 140, a plurality of control buttons 150, a selection switch 160, a pair of loudspeakers 170[0:1] and a solar panel 180. The display screen 110 may be made of a liquid crystal display (LCD) panel with size less than 9 inches in diagonal length. The display screen 110 may have multiple display fields for displaying such information as a first number 112, a math operation symbol 114, a second number 116, an equal sign 118 and a resultant number field 120. The first number 112 and the second number 116 may be randomly generated. The math operation symbol 114 represents a selected math operation. A user can select a particular math operation by pressing one of the math operation selection buttons 130. For elementary arithmetic operations, there are only four selection buttons, namely, addition (+), subtraction (−), multiplication (×) or division (÷). For instance, when a “+” selection button is pressed, the user intends to practice additions. Then the math educational apparatus 100 performs additions on the randomly generated first and second numbers. The first and second numbers together with the operation symbol 114 post a math question to the user. The user may give an answer by pressing one or more of the number input buttons 140. The user's answer will then be displayed in the resultant number field 120. If the answer is correct, the math educational apparatus 100 may produce an audio approval message through the loudspeakers 170[0:1]. Otherwise, the math educational apparatus may erase the user entered number from the resultant number field 120, and asks the user to try again through the loudspeakers 170[0:1].

Additionally, the display screen 110 may also have a counter field 124 and a status indication field 126. The counter field 124 may display a number of successfully answered questions. The status indication field 126 may display a prompt, such as a question mark “?”, when a question is posted on the display screen 110. The status indication field 126 may change to an approval mark, such as a “√”, when the question is correctly answered. On the other hand, a disapproval mark, such as an “X”, will be displayed. When a question is correctly answered, the math educational apparatus 100 will move on with a new question. If the answer is wrong, the same question will stay on the display screen 110. The user can enter another answer, or press one of the control buttons 150. One of the of control buttons 150 is a give-up button 152, when pressed, the math educational apparatus 100 will show a correct answer on the display screen 110 for a predetermined period of time before posting a new question. Another one of the plurality of control buttons 150 is a skip button 156, when pressed, the math educational apparatus 100 will skip the question without displaying a correct answer, and then post a new question. In fact, at any time, when the skip button 156 is pressed, the math educational apparatus 100 will skip to a new question. The user want to skip a question may simply because it is too easy or has been posted before.

Referring again to FIG. 1, the selection switch 160 functions as level selector for users to select questions' level of difficulty. For instance, when the selection switch 160 is switched to a level 1 and the addition button “+” is pressed, the math education apparatus 100 will post only single digit numbers for both the first number 112 and second number 116. Also in the addition arithmetic operation, when the selection switch 160 is switched to a level 2, then the math apparatus 100 may post single digit numbers for the first number 112, but two digit numbers for the second number 116.

As shown in FIG. 1, the math educational apparatus 100 has the solar panel 180 to provide power thereto. The solar power is feasible because the math educational apparatus 100 requires very little computational power. The solar power is also more desirable not only because it is more economical to operate, but also because young students the math educational apparatus 100 are intended for will be limited to use it only in a well-lighted place.

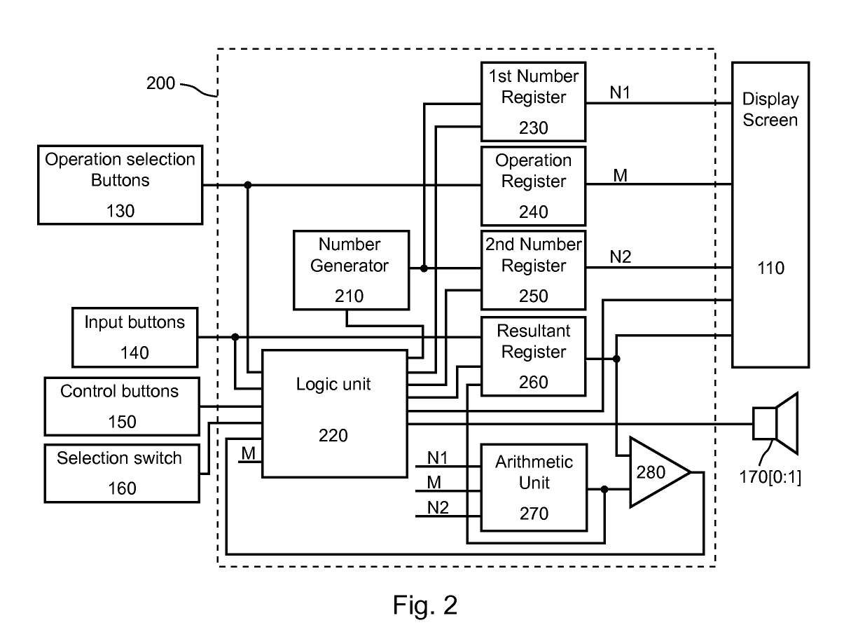

FIG. 2 is a block diagram illustrating a circuit 200 implementing the functions of the math educational apparatus 100 of FIG. 1. The circuit 200 comprises a number generator 210, a logic unit 220, a first number register 230, an operation register 240, a second number register 250, a resultant register 260, an arithmetic unit 270 and comparator 280. The first number register 230, the operation register 240, the second number register 250 and the resultant register 260 drive the first number 112, the operation symbol 114, the second number 116 and the resultant number field 120, respectively, on the display screen 110. The operation register 240 takes inputs from the operation selection buttons 130 of FIG. 1. Similarly, the resultant register 260 takes input from the input buttons 140. The logic unit 220 takes signals from the control buttons 150 and the selection switch 160. The logic unit 220 also drives the loudspeakers 170[0:1].

The number generator 210 is controlled by the logic unit 220 to generate numbers. An output of the number generator 210 is coupled to both the first number register 230 and the second number register 250. A number appearing on the output of the number generator 210 will be taken by either the first number register 230 or the second number register 250 at the control of the logic unit 220.

The operation register 240 is coupled to the operation selection buttons 130 for storing a user selected arithmetic operation. An output of the operation register 240 is coupled to an input of the logic unit through connect M. When the user selects addition by pressing the “+” button shown on FIG. 1, the logic unit 220 will instruct the number generator 210 to sequentially generate two random numbers, one for the first number register 230 and the other for the second number register 250. Multiplication is similar to the addition operation. When division is selected by pressing the “−” button shown in FIG. 1, the logic unit will instruct the number generator 210 to randomly generate a first number for the second number register 250, and then generate a second number being a multiple of the first number for the first number register 230. In subtraction operation, the logic unit 220 will ensure that the first number register 230 receives a bigger number than the second number register 250 does.

The number generator 210 may generate each time a single digit decimal number. But both the first number register 230 and the second number register 250 may be multi-digits shift registers. For a two digit number to be stored in the first number register 230, for instance, the number generator 210 will have to generate twice, and the first number register 230 will have to shift once. When the selection switch 160 of FIG. 1 is switched to a lower level, the logic unit 220 may instruct that only one digit numbers will be stored in both the first number register 230 and the second number register 250.

The outputs of the first number register 230, the operation register 240 and the second number register 250 are also coupled to inputs of the arithmetic unit 270. As described earlier, these outputs are posted on the display screen. The arithmetic unit 270 calculates a correct answer from the posted numbers. The correct answer is send to the comparator 280 where the correct answer is compared with a content of the resultant register 260. Once the resultant register 260 collects a user's input number, the logic unit 220 will instruct the resultant register 260 to be replaced by the correct answer from the arithmetic unit 270. The logic unit 220 may allow the user's input number on display for a first predetermined period of time, e.g., 2 second, before being replaced. In case the user's input number matches the correct answer, the logic unit 220 may output pre-recorded approval messages through the loudspeakers 170[0:1] and the status indication field 126 of FIG. 1. Otherwise, pre-recorded disapproval messages will be output instead. After the correct answer being displayed on the display screen 110 for a second predetermined period of time,

e.g., 5 second, the logic unit 220 will reset the first number register 230 and the second number register 250, and instruct the number generator 210 to generate numbers for another round of question. The control buttons 150 can also cause the logic unit 220 to start a new round of question.

The logic unit 220 may contain a counter (not shown) to record a number of times the user has answered questions, and display the number of times on the counter field 124 on the display screen 110.

The number generator 210 may have a plurality of memory cells and an address generator (not shown). Each memory cell stores a number. The address generator provides addresses for accessing the memory cells. The address generator is controlled by the logic unit 220. A skilled artisan may device many other kinds of number generators.

The logic unit 220 may be implemented by a specifically designed state machine or a general purpose microcontroller (not shown). When implemented by the general purpose microcontroller, many of the circuit 200, such as the arithmetic unit 270, the comparator 280 and the various registers 230, 240, 250 and 260 may be incorporated in the microcontroller. Most general purpose microcontrollers come with embedded memories. The various registers 230, 240, 250 and 260 may simply be various storage units with the embedded memories. Besides, some of the functions, such as generating numbers, performed by the circuit 200 may be carried out by software.

In general, the entire circuit 200 is preferably designed and manufactured into a single chip to reduce cost, size and power consumption. With lower power consumption, the math educational apparatus 100 will be more readily powered by the solar panel 180 of FIG. 1.

A skilled artisan may also recognize that the number input buttons 140 of FIG. 1 can be replaced with other input means such as hand-writing or even voice recognition systems. But such input means require significantly more computing power. Therefore, costs of making such complicated math educational apparatus would be much higher than the one with button input means.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A math educational apparatus, comprising:
a first and second storage unit coupled to at least one number generator;
a third storage unit coupled to an arithmetic operation selection device;
an arithmetic unit for performing a correct arithmetic operation on contents of the first and second storage unit, the arithmetic operation being determined by a content of the third storage unit;
a fourth storage unit coupled to a number input device;
a comparator for comparing an output of the arithmetic unit and a content of the fourth storage unit; and
a display device coupled to outputs of the first, second, third and fourth storage unit for displaying contents thereof,
wherein displayed contents of the first, second and third storage unit represents a math question and a displayed content of the fourth storage unit represents an answer to the math question.

2. The math educational apparatus of claim 1 further comprises a solar panel for supplying power to the math educational apparatus.

3. The math educational apparatus of claim 1, wherein the arithmetic operation selection device comprises an addition selection button, a subtraction selection button, a multiplication selection button and a division selection button.

4. The math educational apparatus of claim 1, wherein the number input device comprises a device selected from the group consisting of a plurality of number buttons, a hand-writing recognition system and a voice recognition system.

5. The math educational apparatus of claim 1 further comprising a logic unit configured to control data receiving of the first, second and fourth storage unit.

6. The math educational apparatus of claim 5, wherein the fourth storage unit is further coupled to an output of the arithmetic unit, wherein the fourth storage unit stores a number from the number input device for a first predetermined period of time and then stores a number from the arithmetic unit for a second predetermined period of time, and the data receiving changed from the number input device to the arithmetic unit is controlled by the logic unit.

7. The math educational apparatus of claim 1 further comprising a counter for recording a number of unique arithmetic operations performed by the arithmetic unit, the content of the counter being supplied to the display device for display.

8. The math educational apparatus of claim 1, wherein the display device comprises a liquid crystal display panel.

9. The math educational apparatus of claim 1 further comprising one or more loudspeakers coupled to the logic unit for announcing pre-recording messages.

10. A math educational apparatus, comprising:
a first and second storage unit coupled to at least one number generator;
a third storage unit coupled to an arithmetic operation selection device;
an arithmetic unit for performing a correct arithmetic operation on contents of the first and second storage unit, the arithmetic operation being determined by a content of the third storage unit;
a fourth storage unit coupled to both a number input device and an output of the arithmetic unit;
a logic unit configured to control data receiving of the first, second and fourth storage unit;
a comparator for comparing an output of the arithmetic unit and a content of the fourth storage unit; and
a display device coupled to outputs of the first, second, third and fourth storage unit for displaying contents thereof,
wherein displayed contents of the first, second and third storage unit represents a math question and a displayed content of the fourth storage unit represents an answer to the math question, the fourth storage unit stores a number from the number input device for a first predetermined period of time and then stores a number from the arithmetic unit for a second predetermined period of time, and the data receiving changed from the number input device to the arithmetic unit is controlled by the logic unit.

11. The math educational apparatus of claim 10 further comprises a solar panel for supplying power to the math educational apparatus.

12. The math educational apparatus of claim 10, wherein the arithmetic operation selection device comprises an addition selection button, a subtraction selection button, a multiplication selection button and a division selection button.

13. The math educational apparatus of claim 10, wherein the number input device comprises a device selected from the group consisting of a plurality of number buttons, a hand-writing recognition system and a voice recognition system.

14. The math educational apparatus of claim 10 further comprising a counter for recording a number of unique arithmetic operations performed by the arithmetic unit, the content of the counter being supplied to the display device for display.

15. The math educational apparatus of claim 10, wherein the display device comprises a liquid crystal display panel.

16. The math educational apparatus of claim 10 further comprising one or more loudspeakers coupled to the logic unit for announcing pre-recording messages.

17. A math educational apparatus, comprising:
a first and second storage unit coupled to at least one number generator;
a third storage unit coupled to an arithmetic operation selection device;
an arithmetic unit for performing a correct arithmetic operation on contents of the first and second storage unit, the arithmetic operation being determined by a content of the third storage unit;
a fourth storage unit coupled to a number input device;
a comparator for comparing an output of the arithmetic unit and a content of the fourth storage unit;
a solar panel for supplying power to the math educational apparatus; and
a display device coupled to outputs of the first, second, third and fourth storage unit for displaying contents thereof,
wherein displayed contents of the first, second and third storage unit represents a math question and a displayed content of the fourth storage unit represents an answer to the math question.

18. The math educational apparatus of claim 17, wherein the arithmetic operation selection device comprises an addition selection button, a subtraction selection button, a multiplication selection button and a division selection button.

19. The math educational apparatus of claim 17, wherein the number input device comprises a device selected from the group consisting of a plurality of number buttons, a hand-writing recognition system and a voice recognition system.

20. The math educational apparatus of claim 17 further comprising a logic unit configured to control data receiving of the first, second and fourth storage unit.

21. The math educational apparatus of claim 20, wherein the fourth storage unit is further coupled to an output of the arithmetic unit, wherein the fourth storage unit stores a number from the number input device for a first predetermined period of time and then stores a number from the arithmetic unit for a second predetermined period of time, and the data receiving changed from the number input device to the arithmetic unit is controlled by the logic unit.

22. The math educational apparatus of claim 17 further comprising a counter for recording a number of unique arithmetic operations performed by the arithmetic unit, the content of the counter being supplied to the display device for display.

23. The math educational apparatus of claim 17, wherein the display device comprises a liquid crystal display panel.

24. The math educational apparatus of claim 17 further comprising one or more loudspeakers coupled to the logic unit for announcing pre-recording messages.
